(19) United States
(12) Patent Application Publication
(10) Pub. No.: US 2023/0325997 A1
(43) Pub. Date: Oct. 12, 2023

(54) IMAGING CONTROL APPARATUS, IMAGE PICKUP APPARATUS, IMAGING CONTROL METHOD, AND STORAGE MEDIUM

(71) Applicant: CANON KABUSHIKI KAISHA, Tokyo (JP)

(72) Inventor: YUYA EBATA, Kanagawa (JP)

(21) Appl. No.: 18/192,857

(22) Filed: Mar. 30, 2023

(30) Foreign Application Priority Data
Apr. 7, 2022 (JP) 2022-063775

(51) Int. Cl. G06T 5/50; G06T 5/00

(52) U.S. Cl. CPC G06T 5/50; G06T 5/002; G06T 2207/20221; G06T 2207/10048

(57) ABSTRACT

An imaging control apparatus includes a control unit configured to acquire visible light image data and nonvisible light image data through imaging by an imaging unit, a processing unit configured to perform image processing using at least one of the visible light image data and the nonvisible light image data, and a determining unit configured to determine an imaging scene. The control unit controls whether or not to perform imaging for the nonvisible light image data by the imaging unit and image processing using the nonvisible light image data in the processing unit according to a determination result of the imaging scene.

### BACKGROUND

### Technical Field

One of the aspects of the disclosure relates to an imaging control apparatus for an image pickup apparatus that can acquire visible light images and nonvisible light images.

### Description of the Related Art

Nonvisible light image data acquired by imaging nonvisible light such as near-infrared light can be used for image processing for visible light image data acquired by imaging visible light, such as noise reduction, contrast improvement, haze or mist removal, and image stabilizing processing. However, in order to acquire visible light image data and nonvisible light image data through imaging, an image sensor for visible light imaging and an image sensor for nonvisible light imaging are required. Some image sensors can simultaneously perform both visible light imaging and nonvisible light imaging, but it is necessary to perform processing for visible light image data and nonvisible light image data, such as pixel correction, black level correction, and flaw correction due so as to correct errors caused by the image sensors. Therefore, the power consumption is higher than that of an image pickup apparatus that performs only visible light imaging. In addition, imaging using a light source that emits nonvisible light cause higher power consumption due to the energization of the light source.

Japanese Patent Laid-Open No. (JP) 2010-154266 discloses an image pickup apparatus that enables a user to select switching from a state for acquiring visible light image data and nonvisible light image data to a state for acquiring visible light image data according to color change over time. JP 2007-142558 discloses an image pickup apparatus that controls light amounts from a visible light source and a nonvisible light source according to the color temperature of an object.

### SUMMARY

One of the aspects of the embodiment provides an imaging control apparatus, an image pickup apparatus, a control method, and a storage medium, each of which can acquire visible light image data and nonvisible light image data and acquire nonvisible light image data with reduced power consumption.

An imaging control apparatus according to one aspect of the disclosure includes at least one processor, and a memory coupled to the at least one processor. The memory has instructions that, when executed by the processor, perform operations as a control unit configured to acquire visible light image data and nonvisible light image data through imaging by an imaging unit, a processing unit configured to perform image processing using at least one of the visible light image data and the nonvisible light image data, and a determining unit configured to determine an imaging scene. The control unit controls whether or not to perform imaging for the nonvisible light image data by the imaging unit and image processing using the nonvisible light image data in the processing unit according to a determination result of the imaging scene. An image pickup apparatus including the above imaging control apparatus also constitutes another aspect of the disclosure. An imaging control method corresponding to the imaging control apparatus also constitutes another aspect of the disclosure. A non-transitory computer-readable storage medium storing a program that causes a computer to execute the above imaging control method also constitutes another aspect of the disclosure.

Further features of the disclosure will become apparent from the following description of embodiments with reference to the attached drawings. In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or program that, when executed by the CPU, cause the CPU to perform operations corresponding to units or functions. In the hardware context, the term “unit” refers to a hardware element, a circuit, an assembly, a physical structure, a system, a module, or a subsystem. It may include mechanical, optical, or electrical components, or any combination of them. It may include active (e.g., transistors) or passive (e.g., capacitor) components. It may include semiconductor devices having a substrate and other layers of materials having various concentrations of conductivity. It may include a CPU or a programmable processor that can execute a program stored in a memory to perform specified functions. It may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

### BRIEF DESCRIPTION OF THE DRAWINGS

FIG. 1 is a block diagram illustrating the configuration of an image pickup apparatus according to a first embodiment.

FIG. 2 is a flowchart illustrating imaging processing in the image pickup apparatus according to the first embodiment.

FIG. 3 is a flowchart illustrating use/nonuse determination processing of a nonvisible light image in the first embodiment.

FIG. 4 illustrates whether the nonvisible light image can be used and how they are used in the first embodiment.

FIG. 5 illustrates an example of a display image in the first embodiment.

FIG. 6 is a block diagram illustrating the configuration of the image pickup apparatus according to a second embodiment.

FIG. 7 illustrates a layout diagram of filters of an image sensor according to the second embodiment.

FIG. 8 illustrates an example of a display image in a third embodiment.

FIG. 9 illustrates an example of an output image in a fourth embodiment.

FIG. 10 illustrates an example of a display image in a fifth embodiment.

### DESCRIPTION OF THE EMBODIMENTS

Referring now to the accompanying drawings, a description will be given of embodiments according to the disclosure. An image pickup apparatus according to the embodiment includes not only a digital camera, which will be described below, but also an image pickup apparatus provided in various electronic apparatuses. Various electronic apparatuses include a computer device (a personal computer, a tablet computer, a media player, a PDA, a mobile phone, a smartphone, a robot, a drone, an in-vehicle camera, a surveillance camera, etc.).

### First Embodiment

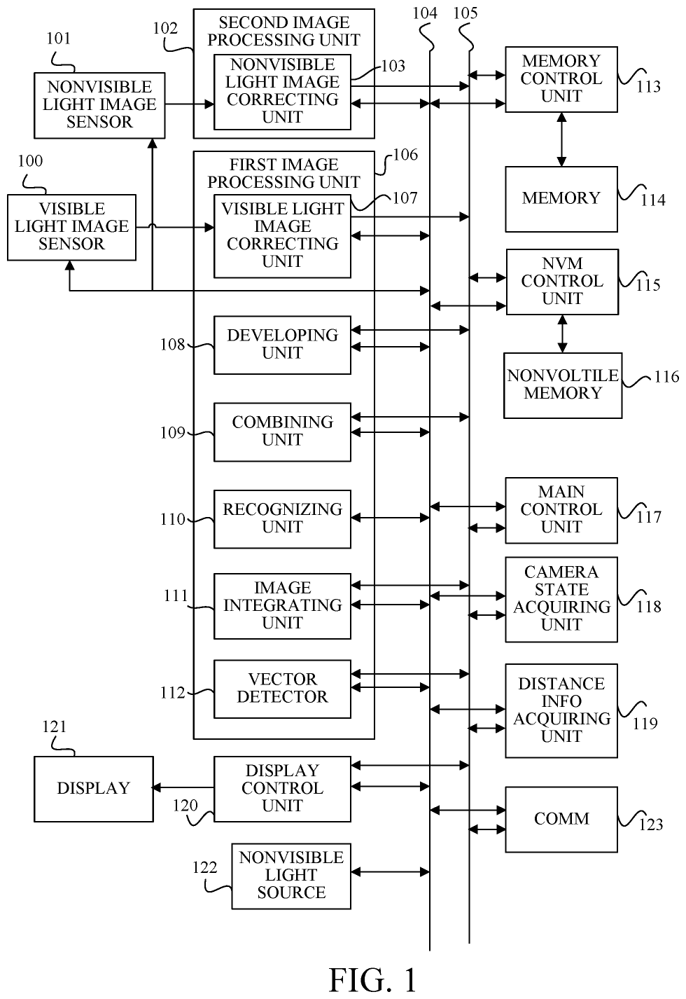

FIG. 1 illustrates the configuration of a digital camera (simply referred to as a camera hereinafter) according to a first embodiment. The camera includes a visible light image sensor 100, a nonvisible light image sensor 101, a first image processing unit 106, a second image processing unit 102, a control bus 104, a data bus 105, a memory control unit 113, a memory 114, a nonvolatile memory (NVM) control unit 115, and a nonvolatile memory 116. The camera further includes a main control unit 117 (imaging control apparatus), a camera state acquiring unit 118, and a distance information acquiring unit 119. The camera further includes a display control unit 120, a display 121, a nonvisible light source 122, a communication unit (COMM) 123, an unillustrated compressor/decompressor, and an unillustrated external recorder.

The visible light image sensor (first imaging unit for visible light) 100 is a photoelectric conversion element such as a CCD sensor or a CMOS sensor, and is configured to convert visible light (object image) received through red (R), green (G), and blue (B) color filters into an electrical signal and to generate pre-correction visible light image data. The R, G, and B color filters are arranged in a predetermined pattern for a plurality of pixels on the imaging plane of the visible light image sensor 100, have light transmittance peaks in the wavelength bands of corresponding colors, and block light transmission in the other wavelength bands.

The nonvisible light image sensor (second imaging unit for nonvisible light) 101 is a photoelectric conversion element such as a CCD sensor or a CMOS sensor, and is configured to convert nonvisible light (object image) received through a near-infrared filter into an electric signal, and to generate pre-correction nonvisible light image data. The near-infrared filter is disposed on each of a plurality of pixels on the imaging plane of the nonvisible light image sensor 101, has a light transmittance peak in the near-infrared wavelength band, and blocks light transmission in other wavelength bands. The nonvisible light image sensor 101 may image nonvisible light in a wavelength band other than the near-infrared wavelength band. The visible light image sensor 100 and the nonvisible light image sensor 101 constitute an imaging unit.

The second image processing unit 102 includes a nonvisible light image correcting unit 103 and an unillustrated Direct Memory Access Controller (DMAC). The nonvisible light image correcting unit 103 performs image processing such as pixel correction, black level correction, shading correction, and flaw correction for the pre-correction nonvisible light image data generated by the nonvisible light image sensor 101 and generates nonvisible light image data. The DMAC of the second image processing unit 102 is connected to the data bus 105, writes the nonvisible light image data to the memory 114 via the memory control unit 113, reads out the pre-correction nonvisible light image data from the memory 114, and outputs to the nonvisible light image correcting unit 103 via the memory control unit 113.

The first image processing unit 106 includes a visible light image correcting unit 107, a developing unit 108, a combining unit 109, a recognizing unit 110, an image integrating unit 111, a vector detector 112, and an unillustrated DMAC. The DMAC is connected to the data bus 105 and writes data processed by the visible light image correcting unit 107, the developing unit 108, the combining unit 109, the recognizing unit 110, the image integrating unit 111, and the vector detector 112 into the memory 114 through the memory control unit 113. The DMAC also reads out data from the memory 114 and outputs it to the visible light image correcting unit 107, the developing unit 108, the combining unit 109, the recognizing unit 110, the image integrating unit 111, and the vector detector 112 via the memory control unit 113. A processing unit includes the first image processing unit 106 and the second image processing unit 102.

The visible light image correcting unit 107 performs image processing such as pixel correction, black level correction, shading correction, and flaw correction for the pre-correction visible light image data generated by the visible light image sensor 100, and generates visible light image data.

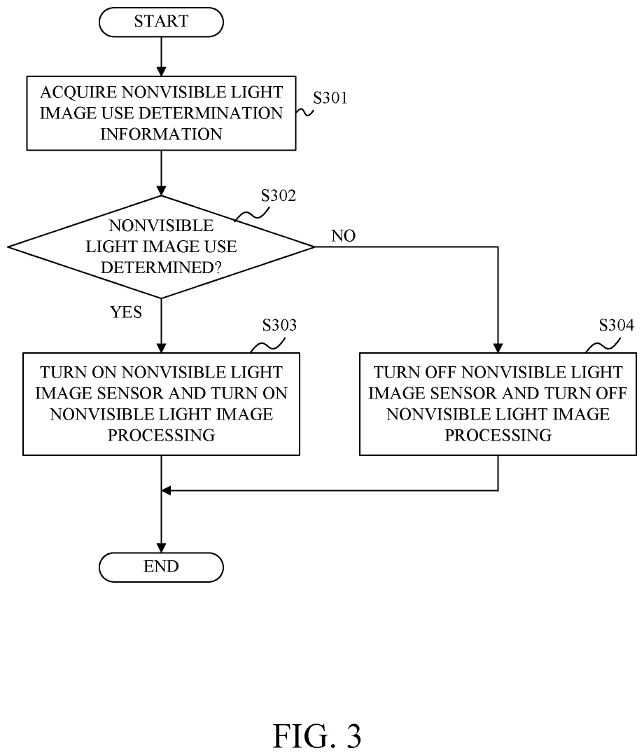

The developing unit 108 performs image processing such as white balance adjustment (AWB), lateral chromatic aberration correction, gamma correction, luminance/color generating processing, geometric deformation, and noise reduction for the visible light image data stored in the memory 114 and the nonvisible light image data. The developing unit 108 also performs image processing such as gamma correction, luminance/color generating processing, geometric deformation, and noise reduction for the nonvisible light image data stored in the memory 114 in step S303 of FIG. 3, which will be described below.

The combining unit 109 combines the visible light image data and the nonvisible light image data in step S303 of FIG. 3, and performs image processing such as noise reduction, contrast improvement, and image stabilization in the combination. In this embodiment, the visible light image sensor 100 and the nonvisible light image sensor 101 are simultaneously driven in the noise reduction and contrast improvement to acquire the pre-correction visible light image data and pre-correction nonvisible light image data at the same time. However, the visible light image sensor 100 and the nonvisible light image sensor 101 may be driven at mutually different times in the noise reduction and contrast improvement to acquire the pre-correction visible light image data and pre-correction nonvisible light image data at the mutually different times, and these image data may be used after a shift between the acquisition times is corrected by the image positioning. By so doing, the image processing performed by the combining unit 109 is also applicable to moving image data. Image stabilization will be described on the premise that the visible light image sensor 100 and the nonvisible light image sensor 101 have different shutter speeds.

The noise reduction removes noise from the visible light image data with the help of the nonvisible light image data, for example, using a composite Dual Bilateral Filter (BF). Since the composite BF uses all of edge information of the nonvisible light image data and the visible light image data, unclear edges in the visible light image data are interpolated and edge preservability and noise removing ability improve.

The contrast improvement acquires, for example, histograms of pixel values of visible light image data and nonvisible light image data. First, in a case where the histogram of the visible light image data (where the horizontal axis represents pixel values and the vertical axis represents frequency) is distributed in a narrower range than that of the histogram of the nonvisible light image data, that is, in a case where a ratio m in the following equation (1) is less than 1, it is determined that the contrast is low and the contrast is improved.

m=histogram range of visible light image data (horizontal axis)/histogram range of nonvisible light image (horizontal axis) (1)

Next, the contrast improvement extracts a luminance signal from the visible light image data, wavelet-transforms the luminance signal, and separates it into low-frequency components and high-frequency components. Then, luminance values of a low-frequency component in which a histogram having a gradient magnitude in a spatial direction relative to a low-frequency component is correlated with a histogram having a gradient magnitude of the nonvisible light image data and the original (visible light image data) low-frequency component are calculated by the following equation (2).

(low-frequency component with aligned histogram×m+original low-frequency component×(1−m))/2 (2)

The contrast improvement calculates a luminance value of the high-frequency component by equation (3).

(high-frequency component of nonvisible light image data×m+original high-frequency component×(1−m))/2 (3)

The contrast improvement generates image data with improved contrast by inverse wavelet transforming the luminance value of the low-frequency component and the luminance value of the high-frequency component.

The image stabilization increases a shutter speed of imaging by the nonvisible light image sensor 101 and acquires a plurality of frames of nonvisible light image data, for example, in a case where the shutter speed of imaging by the visible light image sensor 100 is slow and an image blur may occur due to camera shake caused by manual shake or the like. The image stabilization estimates a blur kernel from a plurality of frames of nonvisible light image data and performs deconvolution for the visible light image data using the estimated blur kernel.

A method other than the above methods may be used as the noise reduction, contrast improvement, and image stabilization performed by the combining unit 109.

The recognizing unit 110 performs object recognition that detects one or more predetermined candidate objects areas (candidate areas) from one frame of input image data using deep learning (DL). The recognizing unit 110 correlates, for each candidate area, an object class indicating a position and size within a frame, a type of a candidate object (automobile, airplane, bird, insect, human body, head, pupil, cat, dog, etc.) and its reliability with the input image data. The number of areas detected for each object class is counted. An imaging scene (sky, night view (scene), landscape, sports, portrait, food, race, etc.) of the input image data is recognized, and its reliability is correlated with the input image data.

The recognizing unit 110 can detect candidate areas using known technologies for detecting characteristic areas such as human or animal face areas. For example, the recognizing unit 110 may be configured as a class discriminator that has been trained using learning data. The identification (classification) algorithm is not particularly limited. The recognizing unit 110 can be realized by training a discriminator implemented with multi-class logistic regression, support vector machine, random forest, neural network, or the like.

The object recognition using the nonvisible light image data may reduce the recognition rate if the learning model of the recognizing unit 110 is a learning model for visible light images and thus may the learning model of the recognizing unit 110 may be changed to a learning model for nonvisible light images. A learning model is a model that evaluates the input content in some way and outputs it as an output value and is acquired through learning using a data set for a certain purpose.

The recognizing unit 110 may not use DL. For example, in a case where the entire image is dark and there are a plurality of places having luminance values, the captured scene may be determined to be a night view.

The recognizing unit 110 also performs object tracking using DL (DL tracking) or object tracking without using DL (non-DL tracking). The DL tracking estimates a position and size of an object area to be tracked using a trained multi-layer neural network including convolution layers. More specifically, it has a function of extracting feature points for object areas for each object class that can be a target and feature amounts included in the feature points, and a function of correlating the extracted feature points between frames. Such DL tracking estimates the position and size of the object area to be tracked in the current frame using the feature points in the current frame that are correlated with the feature points in the object area to be tracked in the past frame. Then, it outputs the position, size, and reliability score of the object area to be tracked, which has been estimated for the current frame.

The reliability score indicates the correlation reliability of feature points between frames, that is, the reliability of the estimation result of the object area to be tracked. In a case where the reliability score indicates that the correlation reliability of feature points between frames is low, the object area estimated in the current frame is likely to be an area relating to an object different from the object area to be tracked in the past frame.

On the other hand, the non-DL tracking estimates the object area to be tracked in the current frame by a method that does not use deep learning. The non-DL tracking here estimates using pattern matching by setting the object area to be tracked in the past frame as a template, but another method may be used.

The image integrating unit 111 divides the input image data into a plurality of rectangular areas, integrates the pixel values for each area, and outputs the integration result. The integration result is used, for example, for auto-exposure (AE), white balance (WB) adjustment of the developing unit 108, and the like.

The vector detector 112 detects a motion vector of an object between the previous frame and the current frame in the input image data using a block matching method or the like. However, another method may be used to detect a motion vector.

Either or both of visible light image data and nonvisible light image data are input as input image data to the recognizing unit 110, the image integrating unit 111, and the vector detector 112. The recognizing unit 110, the image integrating unit 111, and the vector detector 112 may select input image data from the visible light image data and nonvisible light image data according to the imaging scene recognized by the recognizing unit 110.

The control bus 104 is used for the main control unit 117 to access the first image processing unit 106, the second image processing unit 102, the visible light image sensor 100, the nonvisible light image sensor 101, the display control unit 120, the memory control unit 113, the nonvolatile memory control unit 115, the camera state acquiring unit 118, the distance information acquiring unit 119, the nonvisible light source 122, and the communication unit 123.

The data bus 105 is used to transfer between the memory 114 or nonvolatile memory 116 and the main control unit 117, the first image processing unit 106, the second image processing unit 102, the display control unit 120, the camera state acquiring unit 118, the distance information acquiring unit 119, and the communication unit 123.

The memory control unit 113 writes data into and reads data from the memory 114 in accordance with instructions from the main control unit 117, the first image processing unit 106, the second image processing unit 102, the display control unit 120, the camera state acquiring unit 118, the distance information acquiring unit 119, and the communication unit 123. The memory 114 includes a DRAM or the like, and stores a predetermined amount of still image data, moving image data, and audio data for a predetermined time, constants, programs, and the like for the operations of the main control unit 117.

The nonvolatile memory control unit 115 writes data into and reads data from the nonvolatile memory 116 in accordance with instructions from the main control unit 117. The nonvolatile memory 116 is an electrically erasable/recordable memory, such as an EEPROM. The nonvolatile memory 116 stores constants, programs, and the like for the operation of the main control unit 117.

The main control unit 117 includes a microcomputer and controls the entire camera. That is, the main control unit 117 issues various instructions to each functional block in the camera and executes various processing. The main control unit 117 controls the first image processing unit 106, the second image processing unit 102, the visible light image sensor 100, the nonvisible light image sensor 101, the display control unit 120, the memory control unit 113, and the nonvolatile memory control unit 115, the camera state acquiring unit 118, the distance information acquiring unit 119, the nonvisible light source 122, and the communication unit 123 connected via the control but 104. The main control unit 117 executes various processing according to programs recorded in the nonvolatile memory 116.

The main control unit 117 determines an imaging scene to be imaged by the camera based on outputs from the recognizing unit 110, the image integrating unit 111, the vector detector 112, the camera state acquiring unit 118, and the distance information acquiring unit 119, as will be described below. The recognizing unit 110, the image integrating unit 111, the vector detector 112, the camera state acquiring unit 118, the distance information acquiring unit 119, and the main control unit 117 constitute a determining unit.

The camera state acquiring unit 118 acquires the state and operation setting of the camera. The camera state is the posture, shake, etc. of the camera acquired by an unillustrated gyro sensor. The camera operation setting is made by the user viewing a menu screen on the display 121, such as a shutter speed, AE ON/OFF, auto WB (AWB)/manual WB, and the like.

The distance information acquiring unit 119 acquires object distance information, which is a distance from the camera to an object. The object distance can be calculated, for example, based on the Time of Flight (ToF), that is, by irradiating near-infrared light from the camera onto the object, by measuring a time period from the irradiation to when the reflected light from object reaches the camera, and by multiplying this period by the light speed. Another method may be used to acquire the object distance.

The display control unit 120 controls display of image data and user interface (UI) on the display unit (monitor) 121. The display 121 includes a liquid crystal panel, an organic EL panel, or the like, and displays image data, UI, and the like. A display unit includes the display control unit 120 and the display 121.

The nonvisible light source 122 includes a nonvisible light LED or the like, and irradiates the object with nonvisible light under control of a light emitting amount, light emitting timing, light emitting time, irradiation position, and the like from the main control unit 117. The irradiation position is, for example, a position of a person in a case where the person is recognized in imaging data and irradiated with light.

The communication unit 123 transmits to the outside of the camera image data processed by the first image processing unit 106 and the second image processing unit 102, visible light RAW data and nonvisible light RAW data unprocessed by the developing unit 108, compressed image data and the like compressed in a JPEG format, a MPEG format, and the like. The visible/nonvisible light RAW data is image data that has been unprocessed or processed by the visible light image correcting unit 107 and the nonvisible light image correcting unit 103. The communication unit 123 exchanges image data and the like with an external device. The communication unit 123 communicates with the external device by either or both of wired communication and wireless communication.

Although not illustrated, the camera includes a compressor/decompressor unit for compressing each image data into the JPEG format, MPEG format, etc., and decompressing compressed data, and an external recorder for recording image data into an external recording medium.

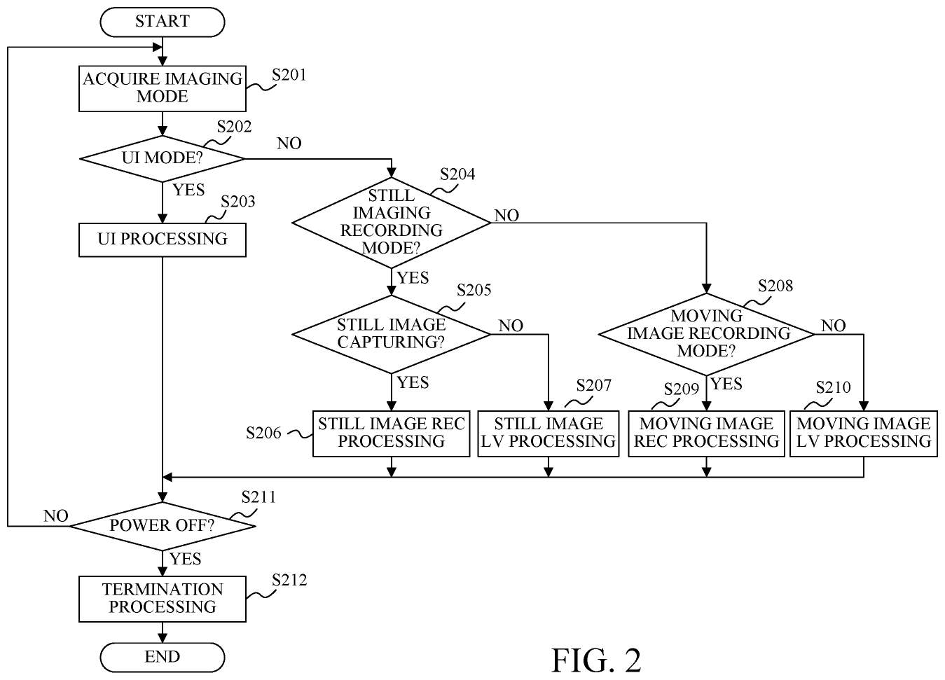

A flowchart in FIG. 2 illustrates imaging processing executed by the main control unit 117 according to the program after the camera is powered on. After the power is turned on, the main control unit 117 performs predetermined initialization processing and then enters imaging processing.

In step S201, the main control unit 117 acquires an imaging mode set in the camera and stored in the memory 114. The imaging mode includes a UI mode, a still image recording mode (single shot/continuous imaging mode), a moving image recording mode, and the like.

In step S202, the main control unit 117 determines whether or not the imaging mode acquired in step S201 is the UI mode. In a case where it is the UI mode, the flow proceeds to step S203.

In step S203, the main control unit 117 displays the UI on the display 121, and writes setting information made by the user through the UI into the memory 114. Then, the UI mode is exited and the flow proceeds to step S211. The setting here includes, for example, camera operation, still image processing (step S206), still image live-view (LV) processing (step S207), moving image recording processing (step S209), and moving image LV processing (step S210), which will be described below. More specifically, it includes turning on and off of a power saving mode of the camera, AWB/MWB, continuous imaging mode and the continuous imaging number in the still image processing, the number of recording pixels and frame rate in the moving image recording processing, and the like. If the nonvisible light source 122 and the nonvisible light image sensor 101 are used to acquire nonvisible light image data, power consumption becomes higher than a case where they are not used. Therefore, nonuse of nonvisible light image data may always be set in the power saving mode, or the user may set the use/nonuse of power saving nonvisible light image data through the UI.

In a case where a noise reduction level and an image stabilization level in the combining unit 109 can be set to “weak,” “medium,” or “strong,” the use of nonvisible light image data may be set in the “strong” is set through the UI. In LV processing for displaying a live-view image on the display 121, use/nonuse of nonvisible light image data may be set through the UI. In a case where it is determined in step S302 of FIG. 3, which will be described below, that nonvisible light image data is to be used, it may be set whether or not to store nonvisible light RAW data in the memory 114 as nonvisible light image data through the UI. By enabling these settings, in a case where the user will not use nonvisible light RAW data later that does not undergo the noise reduction, contrast improvement, and image stabilization in the combining unit 109, the power required to store the nonvisible light RAW data can be saved and the capacity of the memory 114 can be reduced.

In step S204, the main control unit 117 determines whether or not the imaging mode acquired in step S201 is the still image recording mode. In a case where it is the still image recording mode, the flow proceeds to step S205; otherwise, the flow proceeds to step S208.

In step S205, the main control unit 117 determines whether or not the user has operated an unillustrated shutter button to instruct still image capturing. In a case where the user has instructed the still image recording, the flow proceeds to step S206; otherwise, the flow proceeds to step S207.

In step S206, the main control unit 117 performs the still image recording processing. In the still image recording processing, the first image processing unit 106 (developing unit 108 or combining unit 109) generates still image data as output image data, compresses the still image data in the JPEG format, etc., and stores it in an external recording medium. In a case where the still image recording processing ends, the flow proceeds to step S211.

In step S207, the main control unit 117 performs the still image LV processing. In the still image LV processing, the first image processing unit 106 generates LV image data as output image data, and the LV image data is displayed on the display 121 at the frame rate set in the UI processing in step S203. In the still image LV processing, the driving timings of the visible light image sensor 100 and the nonvisible light image sensor 101 and the visible light image correcting unit 107 and the nonvisible light image correcting unit 103 are controlled. In a case where the still image LV processing ends, the flow proceeds to step S211.

In step S208, the main control unit 117 determines whether or not the imaging mode acquired in step S201 is the moving image recording mode. In a case where it is the moving image recording mode, the flow proceeds to step S209; otherwise, the flow proceeds to step S210.

In step S209, the main control unit 117 performs the moving image recording processing. In the moving image recording processing, the first image processing unit 106 generates image data for each frame, thereby generating moving image data as output image data. Then, the moving image data is compressed in the MPEG format or the like and recorded in an external recording medium. In a case where the moving image recording processing ends, the flow proceeds to step S211.

In step S210, the main control unit 117 performs the moving image LV processing. In the moving image LV processing, similarly to the still image LV processing, the first image processing unit 106 generates LV image data as output image data, and displays the LV image data on the display 121 at the frame rate set in the UI processing in step S203. In the moving image LV processing, the driving timing of the visible light image sensor 100 and the nonvisible light image sensor 101 and the visible light image correcting unit 107 and the nonvisible light image correcting unit 103 are controlled. In a case where the moving image LV processing ends, the flow proceeds to step S211.

In step S211, the main control unit 117 determines whether or not the unillustrated power switch is operated by the user and the camera is powered off. In a case where the power is turned off, the flow proceeds to step S212; otherwise, the flow returns to step S201.

In step S212, the main control unit 117 performs camera operation termination processing. The termination processing updates the nonvolatile memory 116 with the setting information written in the memory 114 in the UI processing of step S203.

A flowchart in FIG. 3 is setting processing of use/nonuse of nonvisible light image data executed by the main control unit 117 in the still image recording processing (step S206), the still image LV processing (step S207), the moving image recording processing (step S209), and the moving image LV processing (step S210) in FIG. 2. The use/nonuse of the nonvisible light image data, in other words, corresponds to execution/non-execution of imaging by the nonvisible light image sensor 101 and processing by the second image processing unit 102.

In step S301, the main control unit 117 acquires nonvisible light image use determination information. More specifically, the main control unit 117 sets (updates) the nonvisible light image use determination information so as to use the nonvisible light image data in a case where the recognition result of the imaging scene by the recognizing unit 110 is a night view, or in a case where the imaging scene is set as a landscape or a night view in the UI processing in step S203. Otherwise, the nonvisible light image use determination information is set so as not to use the nonvisible light image data.

The main control unit 117 can determine a type of light source in the imaging scene based on the integration result of the image integrating unit 111. A blackbody radiation curve can be used to determine the type of light source. At this time, in a case where it is difficult to determine the type of light source because the color temperature of the mercury lamp is close to the color temperature of grass green, in other words, in a case where the scene is determined to have a confusing light source for the type of light source, the nonvisible light image use determination information is set so as to use the nonvisible light image data. Otherwise, the nonvisible light image use determination information is set so as not to use the nonvisible light image data.

In a case where the main control unit 117 determines that the imaging scene is one in which the ISO speed is to be increased by the AE control based on the luminance information calculated from the integration result for each area by the image integrating unit 111, the main control unit 117 sets the nonvisible light image use determination information so as to use the nonvisible light image data. Otherwise, the main control unit 117 sets the nonvisible light image use determination information so as not to use the nonvisible light image data.

In a case where the main control unit 117 determines that the camera shake occurs from the detection result by the gyro sensor of the camera state acquiring unit 118 and determines that the imaging scene is dark, the main control unit 117 sets nonvisible light image use determination information so as to use the nonvisible light image data. Otherwise, the main control unit 117 sets the nonvisible light image use determination information so as not to use the nonvisible light image data. The imaging scene is determined to be dark in a case where the recognition result of the imaging scene by the recognizing unit 110 is a night view, in a case where the imaging scene is set to “night view” in the UI processing, or in a case where it is determined that the imaging scene is one in which the ISO speed is to be increased by the AE control based on the luminance information calculated from the integration result of the image integrating unit 111.

In addition to the use/nonuse of the nonvisible light image data, the nonvisible light image use determination information includes a recognition result of the recognizing unit 110, imaging scene setting in the UI processing, a light source determination result, luminance information, AE control (ISO speed) information, detection results of a camera state (shake, etc.), a motion vector, and object distance information.

In step S302, the main control unit 117 determines whether to use the nonvisible light image data based on the nonvisible light image use determination information acquired in step S301. In a case where the nonvisible light image data is to be used, the flow proceeds to step S303, and in a case where the nonvisible light image data is not to be used, the flow proceeds to step S304.

In step S303, the main control unit 117 turns on the driving of the nonvisible light image sensor 101 so as to acquire the nonvisible light image data, and transitions the camera to a state that can process the nonvisible light image data. At this time, the main control unit 117 controls irradiation/non-irradiation of the nonvisible light from the nonvisible light source 122 onto the object according to the nonvisible light image use determination information. Then, this processing ends.

In step S304, the main control unit 117 turns off the driving of the nonvisible light image sensor 101 so that nonvisible light image data cannot be acquired, and transitions the camera to a state that does not process the nonvisible light image data. Then, this processing ends.

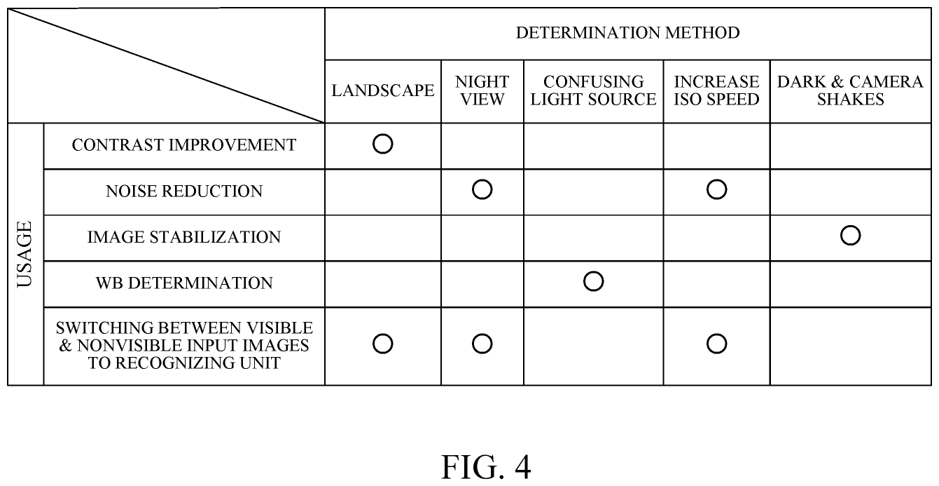

FIG. 4 summarizes the use (circle) and nonuse (blank) of nonvisible light image data for each condition (determination method) and the usage in the case of use. The contrast improvement, noise reduction, and image stabilization are processing performed by the combining unit 109 using the nonvisible light image data. The WB determination means using the nonvisible light image data for the light source determination. Switching between visible and nonvisible input images to the recognizing unit means switching of the input image data to the recognizing unit 110 between visible light data and nonvisible light data.

In a case where the determination method is “landscape” and the usage is “contrast improvement,” the contrast may be reduced due to haze, fog, or the like. Therefore, the main control unit 117 instructs the combining unit 109 to improve the contrast.

In a case where the determination method is “night view” and the usage is “noise reduction,” a noise amount in the visible light image data increases in the night scene, so the main control unit 117 instructs the combining unit 109 to perform noise reduction processing.

In a case where the determination method is “confusing light source” and the usage is “WB determination,” the main control unit 117 determines coefficients for AWB in the developing unit 108 using the nonvisible light image data so that the color of the visible light image data does not become unnatural due to an erroneous light source determination. More specifically, the light source is determined based on a difference in reflectance of the object between visible light and nonvisible light by determining whether the visible light image data is image data of green plants such as grass or image data under a mercury lamp. Then, the coefficient for AWB is determined according to the specified light source.

In a case where the determination method is “increase ISO speed” and the usage is “noise reduction,” increasing the ISO speed increases noise in the visible light image data. Therefore, the main control unit 117 instructs the combining unit 109 to perform noise reduction processing. “The ISO speed has reached the upper limit” may be used instead of “increase ISO speed” for the determination method.

In a case where the determination method is “dark and camera shakes” and the usage is “image stabilization,” image blur may occur in the visible light image data due to the camera shake and the dark object. Therefore, the main control unit 117 instructs the combining unit 109 to perform image stabilizing processing. For the dark object, a blur kernel may be affected by noise in the visible light image data. Therefore, by estimating the blur kernel using the nonvisible light image data, the image stabilization accuracy can be improved.

In a case where the determination method is “landscape” and the usage is “switching between visible and nonvisible input images to recognizing unit,” it is necessary to avoid the recognition rate from lowering due to the influences of haze and fog. If the determination method is “night view” or “increase ISO speed” and the usage is “switching between visible and nonvisible input images to recognizing unit,” it is necessary to void noise in the visible light image data from increasing and the recognition rate from decreasing. Therefore, in these cases, the main control unit 117 switches the input image data of the recognizing unit 110 to the nonvisible light image data. Alternatively, the main control unit 117 may input the visible light image data and the nonvisible light image data to the recognizing unit 110 to acquire a result. In using the nonvisible light image data, the learning model of the recognizing unit 110 may be switched to the learning model for the nonvisible light images.

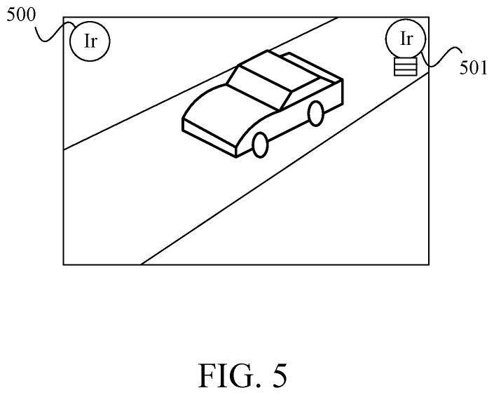

FIG. 5 illustrates an example of an LV image displayed on the display 121. An Ir mark 500 is lit and displayed in a case where the use of nonvisible light image data is set in the UI processing in step S203 to notify the user of the use of nonvisible light image data. By blinking the Ir mark 500 in a case where the nonuse of the nonvisible light image data is set, the user may be prompted to use the nonvisible light image data. An Ir light source mark 501 is a mark indicating that the nonvisible light source 122 is being turned on. The user can turn off the use setting of them by displaying the marks 500 and 501 and notifying the user that the uses of the nonvisible light image data and the nonvisible light source 122 are set, which will increase the power consumption, although the user may want to operate the camera in a power saving state.

In a case where the nonvisible light image data is not used against the intent of the user or because the user forgets the use setting, the Ir mark 500 is displayed blinking to prompt the user to use the nonvisible light image data. Thereby, good output image data can be acquired.

As described above, this embodiment determines the use/nonuse of nonvisible light image data based on the imaging scene, and controls at least one of driving of the nonvisible light image sensor 101, image processing of the second image processing unit 102, and turning on and off of the nonvisible light source 122. Thereby, this embodiment can acquire nonvisible light image data and eventually good output image data while suppressing the power consumption of the camera.

### Second Embodiment

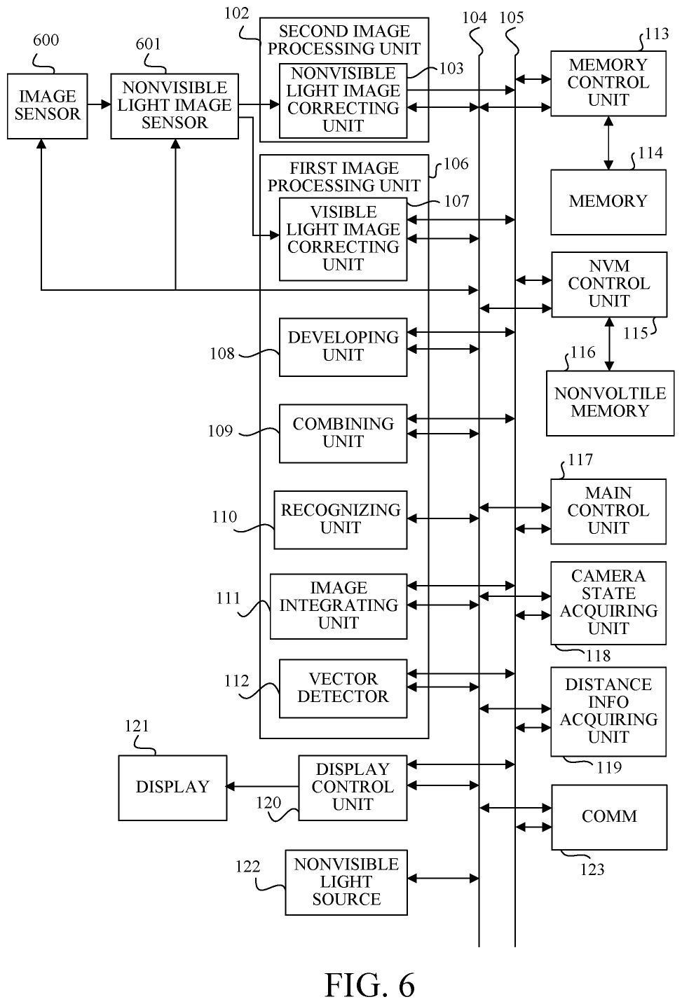

A description will now be given of a second embodiment. FIG. 6 illustrates the configuration of a camera according to the second embodiment. Those elements in FIG. 6, which are corresponding elements in the first embodiment (FIG. 1), will be designated by the same reference numerals as those of the first embodiment, and a description thereof will be omitted.

The camera according to this embodiment includes an image sensor 600 instead of the visible light image sensor 100 and nonvisible light image sensor 101 of the first embodiment, and further includes a nonvisible light pixel separating unit 601.

The image sensor 600 is an image sensor such as a CCD or CMOS sensor, and converts an object image received through R, G, and B color filters and a near-infrared filter into an electrical signal and generates pre-correction image data.

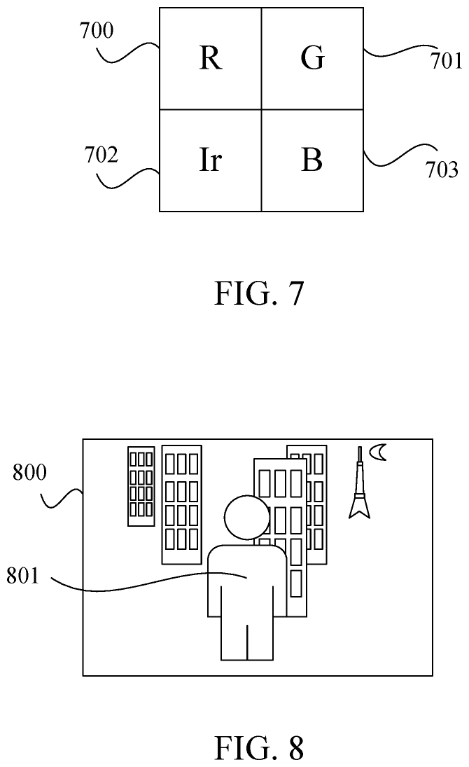

FIG. 7 illustrates an arrangement example of R, G, and B color filters and a near-infrared filter in the image sensor 600. Reference numeral 700 denotes the R color filter, reference numeral 701 denotes the G color filter, and 703 is the B color filter. Reference numeral 702 denotes the near-infrared filter. These color filters 700, 701, and 703 and near-infrared filter 702 are arranged relative to a plurality of pixels on the imaging plane of the image sensor 600 in a pattern illustrated in FIG. 7. The color filters 700, 701, and 703 have light transmittance peaks in the respective color wavelength bands and block light transmission in other wavelength bands. The near-infrared filter 702 has a light transmittance peak in the near-infrared wavelength band and blocks light transmission in other wavelength bands. The image sensor 600 may image nonvisible light in a wavelength band other than the near-infrared wavelength band.

The nonvisible light pixel separating unit 601 generates pre-correction visible light image data in which the pixel corresponding to the near-infrared filter 702 (referred to as an infrared pixel hereinafter) in the pre-correction image data generated by the image sensor 600 is replaced with a pixel corresponding to the G color filter 701. Then, nonvisible light pixel separating unit 601 outputs the pre-correction visible light image data to the visible light image correcting unit 107. The nonvisible light pixel separating unit 601 also generates pre-correction nonvisible light image data consisting of infrared pixels in the pre-correction image data, and outputs it to the nonvisible light image correcting unit 103. At this time, the nonvisible light pixel separating unit 601 converts all pixels corresponding to the color filters 700, 701, and 703 with infrared pixels in order to make the number of pixels in the pre-correction nonvisible light image data equal to that of the pre-correction visible light image data, and generates pre-correction nonvisible light image data.

The image data separating method in the nonvisible light pixel separating unit 601 may be any method as long as the visible light image data and the nonvisible light image data can be separated. The processing after the pre-correction visible light image data and the pre-correction nonvisible light image data are separated is the same as that of the first embodiment.

This embodiment also determines the use/nonuse of nonvisible light image data based on the imaging scene, and controls at least one of driving of the nonvisible light image sensor 101, image processing of the second image processing unit 102, and turning on and off (emitting and non-emitting of light) of the nonvisible light source 122. Thereby, this embodiment can acquire nonvisible light image data and eventually good output image data while suppressing the power consumption of the camera.

### Third Embodiment

A description will now be given of a third embodiment. The configuration of a camera according to this embodiment is the same as that of the camera according to the first or second embodiment.

FIG. 8 illustrates an example of an image 800 displayed on the display 121 of the camera according to this embodiment. The image 800 may be an LV image, a still image, or a moving image. The image 800 illustrates an image acquired by imaging a night view and a person 801. In this case, the main control unit 117 determines the imaging scene based on the recognition result of the person 801 and the night view by the recognizing unit 110 and the luminance information for each area from the image integrating unit 111, and sets (updates) the nonvisible light image use determination information according to the determination result.

In a case where the nonvisible light image use determination information indicates the use of the nonvisible light image data, the main control unit 117 turns on the driving of the infrared pixels on the nonvisible light image sensor 101 or image sensor 600 in step 303 illustrated in FIG. 3 to acquire the nonvisible light image data. In addition, the main control unit 117 transitions the camera to a state that can process nonvisible light image data. At this time, the main control unit 117 controls an emission amount and an irradiation position of the nonvisible light from the nonvisible light source 122 based on the person 801 as the recognition result included in the nonvisible light image use determination information, and the luminance information of the area including the person 801.

By controlling the light emission amount and irradiation position of the nonvisible light source 122 based on the nonvisible light image use determination information, this embodiment does not perform unnecessary nonvisible light irradiation. Therefore, this embodiment can reduce the power consumption of the camera.

### Fourth Embodiment

A description will be given of a fourth embodiment. The configuration of a camera according to this embodiment is the same as that of the camera according to the first or second embodiment.

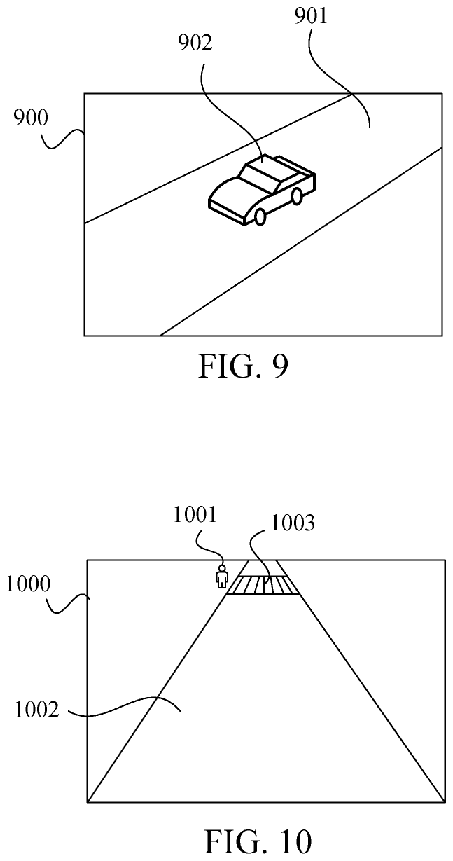

FIG. 9 illustrates an example of an image 900 output to the communication unit 123 in the camera according to this embodiment. The image 900 may be an LV image, a still image, or a moving image. The image 900 illustrates an image acquired by imaging a road 901 and a vehicle 902 to record the vehicle 902 itself or the license plate number of the vehicle 902. In this case, the main control unit 117 determines the imaging scene based on the recognition result of the vehicle 902 by the recognizing unit 110, the luminance information for each area from the image integrating unit 111, the motion vector information from the vector detector 112, and the object tracking result by the recognizing unit 110. Then, the main control unit 117 sets (updates) the nonvisible light image use determination information according to the determination result.

In a case where the nonvisible light image use determination information indicates the use of nonvisible light image data, the main control unit 117 turns on the driving of the infrared pixels on the nonvisible light image sensor 101 or image sensor 600 in step 303 of FIG. 3 so as to acquire the nonvisible light image data. In addition, the main control unit 117 transitions the camera to a state that can process the nonvisible light image data. At this time, the main control unit 117 predicts a position in the next frame of the vehicle 902 as a moving object based on the recognition result of the vehicle 902 included in the nonvisible light image use determination information, the luminance information of the area including the vehicle 902, the motion vector information, and the object tracking result. The main control unit 117 controls the emission amount and the irradiation position of the nonvisible light from the nonvisible light source 122 based on the predicted result of the position in the next frame of the vehicle 902.

By controlling the light emission amount and irradiation position of the nonvisible light source 122 based on the nonvisible light image use determination information, this embodiment also does not perform unnecessary nonvisible light irradiation. Therefore, this embodiment can reduce the power consumption of the camera.

### Fifth Embodiment

A description will now be given of a fifth embodiment. The configuration of a camera according to this embodiment is the same as that of the camera according to the first or second embodiment.

FIG. 10 illustrates an example of an image 1000 displayed on the display 121 in the camera according to this embodiment. The image 1000 may be an LV image, a still image, or a moving image. The image 1000 is an image acquired by imaging a person 1001, a road 1002, and a pedestrian crossing 1003. This image 1000 is acquired by an in-vehicle camera (drive recorder) and used to record the person 1001 and an unillustrated vehicle and to detect the person 1001 crossing the pedestrian crossing 1003 for automatic driving. The main control unit 117 determines the imaging scene based on the recognition result of the person 1001 and the pedestrian crossing 1003 by the recognizing unit 110, the luminance information for each area from the image integrating unit 111, and the object distance information from the distance information acquiring unit 119. Then, the main control unit 117 sets (updates) the nonvisible light image use determination information according to the determination result.

In a case where the nonvisible light image use determination information indicates the use of nonvisible light image data, the main control unit 117 turns on the driving of the infrared pixels on the nonvisible light image sensor 101 or image sensor 600 in step 303 illustrated in FIG. 3 to acquire the nonvisible light image data. In addition, the main control unit 117 transitions the camera to a state that can process the nonvisible light image data. At this time, the main control unit 117 controls the light emission amount and the irradiation position of the nonvisible light emitted from the nonvisible light source 122 based on the recognition results of the person 1001 and the pedestrian crossing 1003 included in the nonvisible light image use determination information, the luminance information of the area including them, and the object distance information.

More specifically, in a case where the luminance information of the area including the person 1001 is lower than a predetermined luminance (that is, the person 1001 is dark) and the distance to the person 1001 is longer than a predetermined distance, the main control unit 117 increases the light emission amount of the nonvisible light source 122. On the other hand, if the distance is shorter than the predetermined distance, the main control unit 117 reduces the light emission amount of the nonvisible light source 122. In a case where the person 1001 cannot be recognized in the recognition result included in the nonvisible light image use determination information, that is, in a case where it is determined that a long distance is imaged based only on the object distance information, the main control unit 117 increases the light emission amount of the nonvisible light source 122.

By controlling the light emission amount and irradiation position of the nonvisible light source 122 based on the nonvisible light image use determination information, this embodiment also does not perform unnecessary nonvisible light irradiation. Therefore, this embodiment can reduce the power consumption of the camera.

Each of the above embodiments can provide an imaging control apparatus, an image pickup apparatus, a control method, and a storage medium, each of which can acquire visible light image data and nonvisible light image data and acquire nonvisible light image data with reduced power consumption.

### Other Embodiments

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2022-063775, filed on Apr. 7, 2022, which is hereby incorporated by reference herein in its entirety.

What is claimed is:

1. An imaging control apparatus comprising:
at least one processor; and
a memory coupled to the at least one processor,
wherein the memory has instructions that, when executed by the processor, perform operations as:
a control unit configured to acquire visible light image data and nonvisible light image data through imaging by an imaging unit;
a processing unit configured to perform image processing using at least one of the visible light image data and the nonvisible light image data; and
a determining unit configured to determine an imaging scene, and
wherein the control unit controls whether or not to perform imaging for the nonvisible light image data by the imaging unit and image processing using the nonvisible light image data in the processing unit according to a determination result of the imaging scene.

2. The imaging control apparatus according to claim 1, wherein the imaging unit includes a first imaging unit for visible light and a second imaging unit for nonvisible light.

3. The imaging control apparatus according to claim 1, wherein the instructions further perform operations as a separating unit configured to separate the visible light image data and the nonvisible light image data from image data generated by the imaging unit.

4. The imaging control apparatus according to claim 1, wherein the determining unit determines the imaging scene according to a setting by a user.

5. The imaging control apparatus according to claim 1, wherein the determining unit determines the imaging scene according to a result of object recognition using at least one of the visible light image data and the nonvisible light image data.

6. The imaging control apparatus according to claim 5, wherein the determining unit selects image data to be used for the object recognition from the visible light image data and the nonvisible light image data according to the imaging scene.

7. The imaging control apparatus according to claim 5, wherein the determining unit uses a learning model for the object recognition, and
wherein the determining unit uses a visible light image learning model in a case where the image data for the object recognition is the visible light image data, and the determining unit uses a nonvisible light image learning model as the learning model in a case where the image data for the object recognition is the nonvisible light image data.

8. The imaging control apparatus according to claim 1, wherein the determining unit determines the imaging scene using luminance information acquired from at least one of the visible light image data and the nonvisible light image data.

9. The imaging control apparatus according to claim 1, wherein the determining unit determines the imaging scene using motion vector information acquired from at least one of the visible light image data and the nonvisible light image data.

10. The imaging control apparatus according to claim 1, wherein the determining unit determines the imaging scene using object distance information.

11. The imaging control apparatus according to claim 1, wherein the control unit controls whether or not to generate the nonvisible light image data and whether or not to execute image processing using the nonvisible light image data according to a determination result of the imaging scene and a shake detection result of an image pickup apparatus.

12. The imaging control apparatus according to claim 1, wherein the control unit controls whether or not to emit a nonvisible light source that irradiates nonvisible light onto an object according to a determination result of the imaging scene.

13. The imaging control apparatus according to claim 1, wherein in a case where the nonvisible light image data is generated and the image processing using the nonvisible light image data is executed, the control unit records the nonvisible light image data in another memory according to a setting by a user.

14. An image pickup apparatus comprising:
an imaging unit; and
the imaging control apparatus according to claim 1.

15. The image pickup apparatus according to claim 14, further comprising a display unit configured to display to a user that the nonvisible light image data is generated and image processing using the nonvisible light image data is performed.

16. The image pickup apparatus according to claim 14, further comprising a display unit configured to prompt a user to execute image processing using the nonvisible light image data in a case where generation of the nonvisible light image data and image processing using the nonvisible light image data is not performed.

17. The image pickup apparatus according to claim 14, further comprising a display unit configured to display to a user that a nonvisible light source that irradiates nonvisible light onto an object with is lit.

18. An imaging control method comprising the steps of:
a control step configured to acquire visible light image data and nonvisible light image data through imaging by an imaging unit;
a processing step configured to perform image processing using at least one of the visible light image data and the nonvisible light image data; and
a determining step configured to determine an imaging scene, and
wherein the control step controls whether or not to perform imaging for the nonvisible light image data by the imaging unit and image processing using the nonvisible light image data in the processing step according to a determination result of the imaging scene.

19. A non-transitory computer-readable storage medium storing a program that causes a computer to execute the imaging control method according to claim 18.
